(19) United States
(12) Patent Application Publication
(10) Pub. No.: US 2013/0337679 A1
(43) Pub. Date: Dec. 19, 2013

(54) ELECTRICAL CONNECTORS AND ASSEMBLY THEREOF WITH IMPROVED GUIDING STRUCTURES

(71) Applicants: Hung-Chi TAI, JHONGHE (TW); Yung-Chih HUNG, JHONGHE (TW)

(72) Inventors: Hung-Chi TAI, JHONGHE (TW); Yung-Chih HUNG, JHONGHE (TW)

(73) Assignee: ALLTOP ELECTRONICS (SUZHOU) LTD., Taicang City (CN)

(21) Appl. No.: 13/596,753

(22) Filed: Aug. 28, 2012

(30) Foreign Application Priority Data
Jun. 19, 2012 (CN) 201210201831.6

(51) Int. Cl. H01R 24/28

(52) U.S. Cl. 439/485; 439/660

(57) ABSTRACT

An electrical connector assembly includes mateable plug connector and receptacle connector. The plug connector includes a U-shaped first tongue and a number of first contacts with flat and rigid contacting portions exposed on the first tongue. The receptacle connector includes a U-shaped receiving cavity configured to receive the first tongue. The first tongue includes a pair of curved outer guiding surfaces and the receiving cavity includes a pair of curved inner guiding surfaces for mating with the curved outer guiding surfaces when the plug connector and the receptacle connector are mated together. Under the guidance of the guiding surfaces, the plug connector can be easily and stably inserted into the receptacle connector.

### BACKGROUND OF THE INVENTION

1. Field of the Invention

The present invention relates to electrical connectors and assembly thereof, and more particularly, to electrical connectors and assembly thereof mounted on circuit boards.

2. Description of Related Art

With high-speed development of notebook computers, there profiles become thinner and thinner. Accordingly, connectors mounted in the notebook computers should trend to be smaller and smaller as well. A conventional connector usually includes an insulative housing and a plurality of contacts retained in the insulative housing. As for a plug connector, the insulative housing usually includes a tongue portion on which contacts are exposed for mating with a corresponding connector. As for a receptacle connector, the insulative housing usually defines a receiving cavity for receiving the tongue portion. With regard to these low profile connectors, how to design suitable guiding structures for guiding insertion of the plug connector and the receptacle connector for assuring stable mating effects is a big problem to those of ordinary skill in the art.

Hence, improved electrical connectors and an assembly thereof with reliable guiding structures are desired.

### BRIEF SUMMARY OF THE INVENTION

The present invention provides an electrical connector assembly including a plug connector and a receptacle connector. The plug connector includes a first insulative housing and a plurality of first contacts retained in the first insulative housing. The first insulative housing includes a first body, a first tongue extending forwardly from the first body and a pair of first extension portions extending backwardly from opposite sides of the first body. The first tongue is essentially U-shaped from a front view. The first tongue includes a rectangular flat portion and a pair of raised portions extending upwardly and outwardly from top corners of the flat portion. The first body jointly with the pair of first extension portions form a U-shaped first mounting space. Each first contact includes a flat and rigid first contacting portion exposed on a top mating surface of the flat portion and a first soldering portion extending into the first mounting space. Each raised portion defines a curved outer guiding surface for being easily inserted into a cavity of the receptacle connector.

The receptacle connector includes a second insulative housing and a plurality of second contacts retained in the second insulative housing. The second insulative housing includes a second body which defines a front end surface, a top surface and a bottom surface. The second body defines an essentially U-shaped receiving cavity recessed backwardly from the front end surface and accordingly forming a second tongue exposed to the receiving cavity. The U-shaped receiving cavity includes a flat cavity extending through the bottom surface of the second body and located below the second tongue and a pair of enlarged holes extending upwardly at opposite sides of the flat cavity. The second tongue defines a bottom mating surface. Each second contact includes an elastic contacting arm extending downwardly beyond the bottom mating surface and a tip end cantileveredly extending from the contacting arm. The second body defines a plurality of heat-dissipation slots extending through the top surface to receive the tip ends of the second contacts.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of an electrical connector assembly with a plug connector inserted in a receptacle connector in accordance with an illustrated embodiment of the present invention;

FIG. 2 is a partly exploded view of the electrical connector assembly as shown in FIG. 1 with first and second metal grounding pieces separated therefrom;

FIG. 3 is a perspective view of the plug connector as shown in FIG. 1;

FIG. 4 is an exploded view of the plug connector as shown in FIG. 3;

FIG. 5 is a perspective view of a first insulative housing of the plug connector;

FIG. 6 is another perspective view of the first insulative housing while taken from a different aspect;

FIG. 7 is a perspective view of a first contact of the plug connector;

FIG. 8 is a perspective view of the receptacle connector as shown in FIG. 1;

FIG. 9 is an exploded view of the receptacle connector as shown in FIG. 8;

FIG. 10 is a perspective view of a second insulative housing of the receptacle connector;

FIG. 11 is another perspective view of the second insulative housing while taken from a different aspect; and

FIG. 12 is a perspective view of a second contact of the receptacle connector.

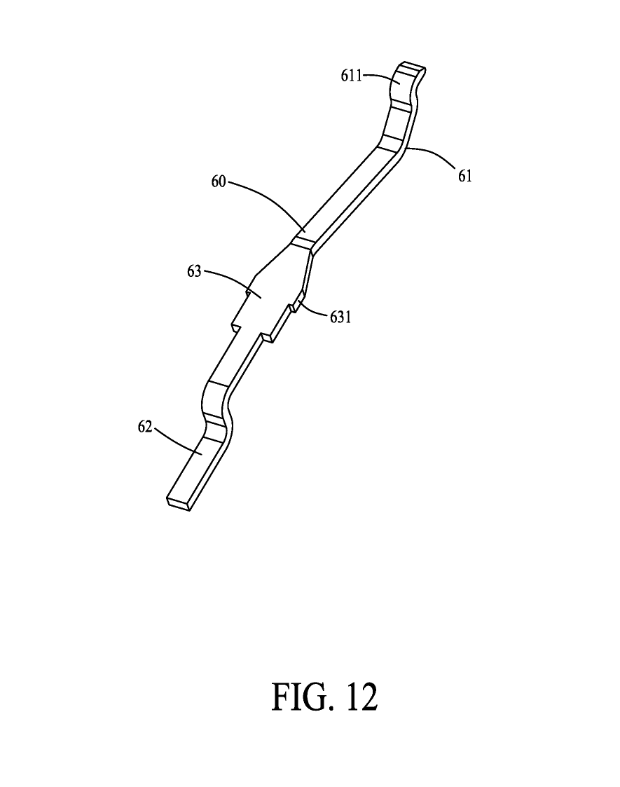

### DETAILED DESCRIPTION OF THE PREFERRED EMBODIMENT

Reference will now be made to the drawing figures to describe the embodiments of the present invention in detail. In the following description, the same drawing reference numerals are used for the same elements in different drawings.

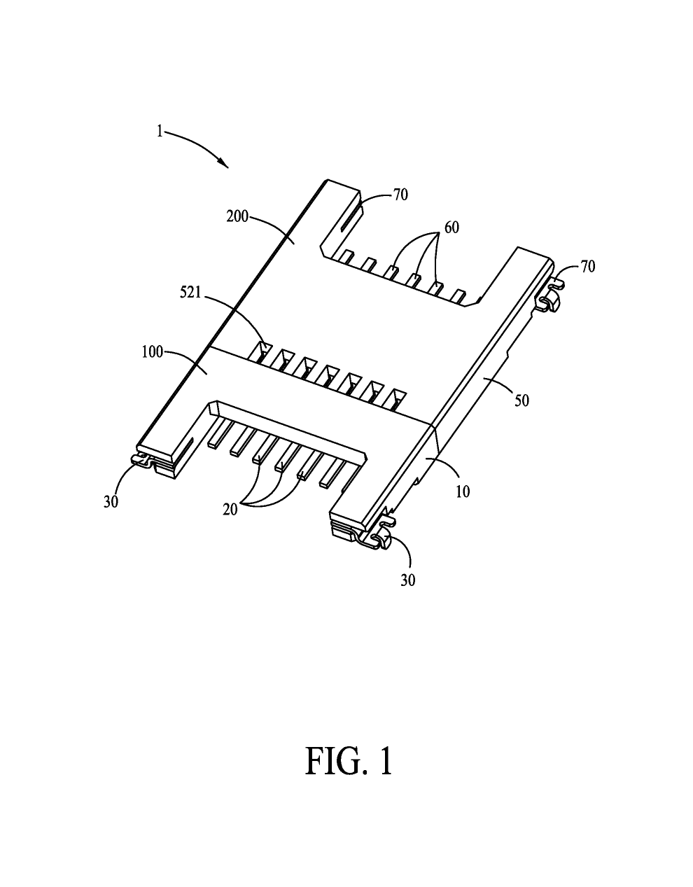

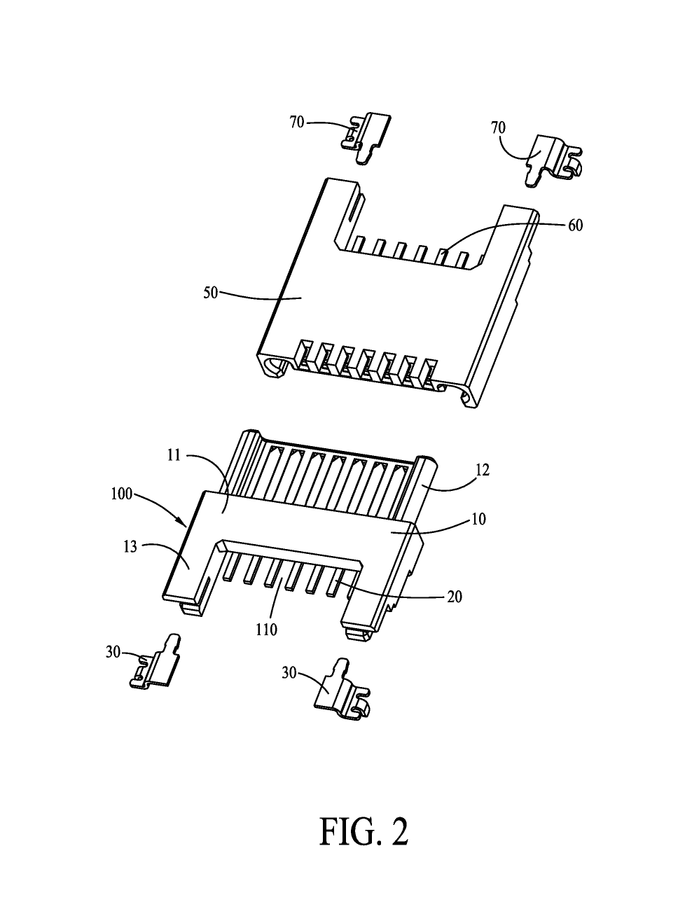

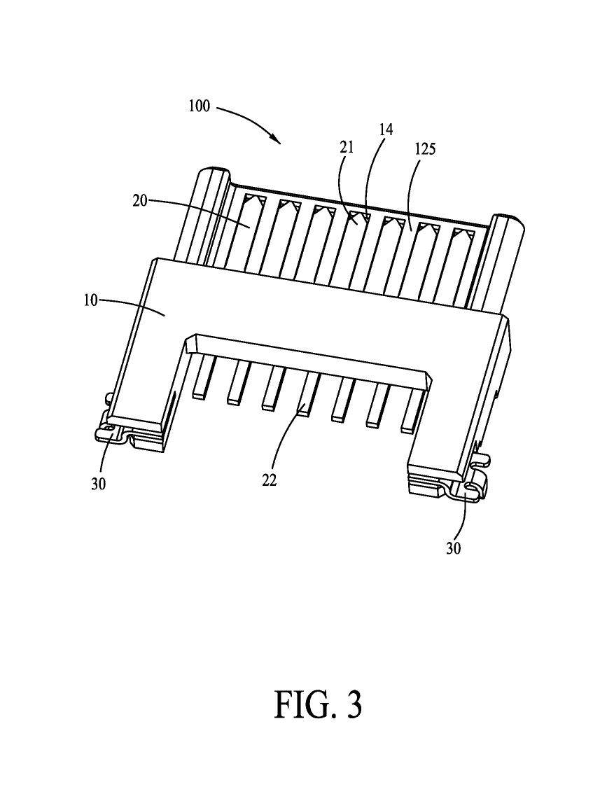

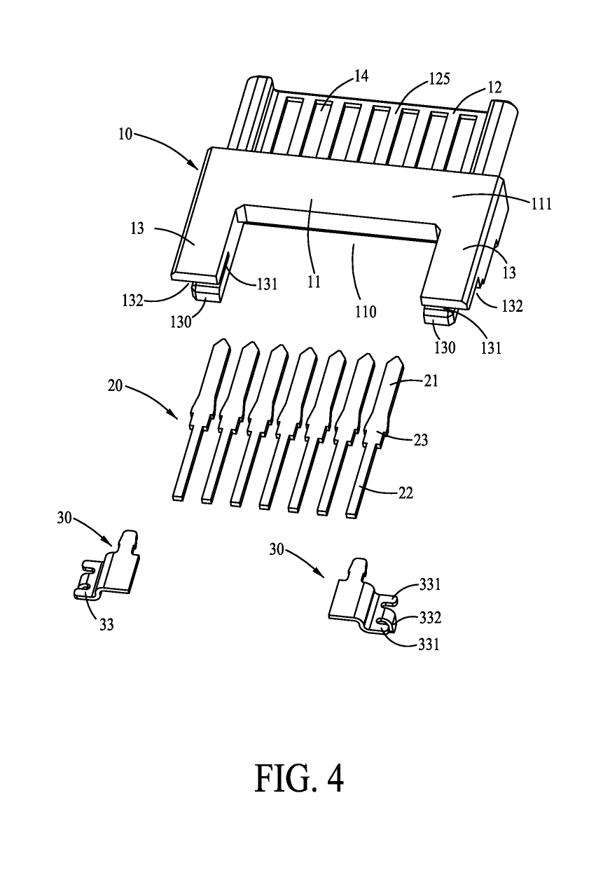

Referring to FIGS. 1 and 2, the present invention discloses an electrical connector assembly 1 including a plug connector 100 and a receptacle connector 200 for mating with the plug connector 100. Both the plug connector 100 and the receptacle connector 200 are surface mounted on a circuit board (not shown). Further referring to FIGS. 3 and 4, the plug connector 100 includes a first insulative housing 10, a plurality of first contacts 20 retained in the first insulative housing 10 and a pair of first metal grounding pieces 30 assembled to the first insulative housing 10.

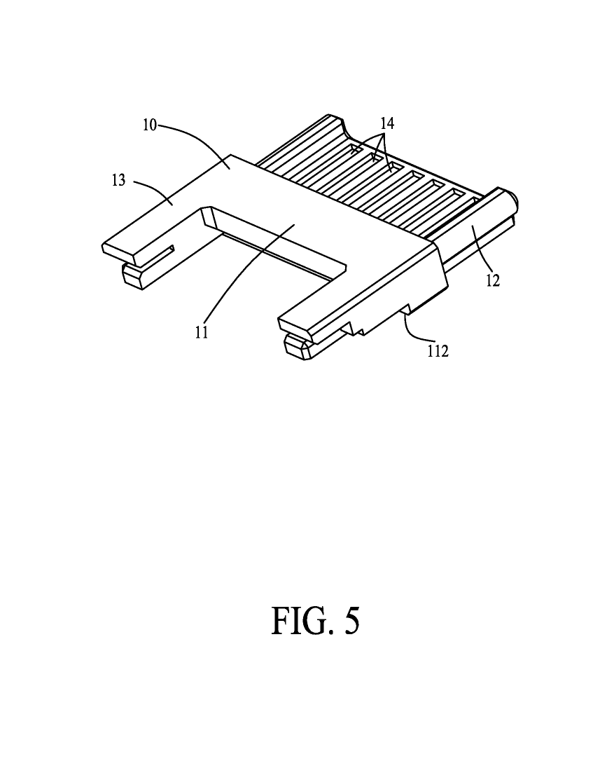

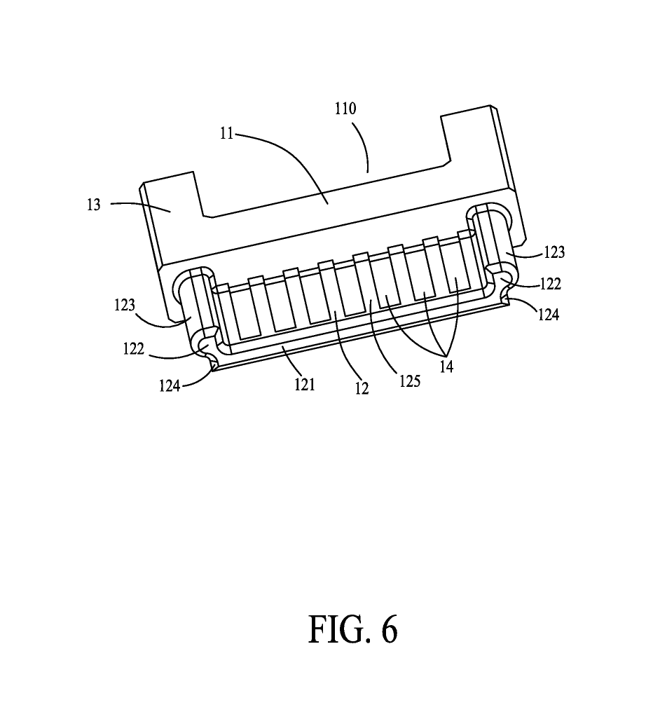

Referring to FIGS. 5 and 6, the first insulative housing 10 includes a first body 11, a first tongue 12 extending forwardly from the first body 11 and a pair of first extension portions 13 extending backwardly from opposite sides of the first body 11. The first body 11 and the pair of first extension portions 13 jointly form a U-shaped first mounting space 110. The first body 11 is flat-shaped and includes a top surface 111 and a bottom surface 112 (shown in FIG. 5) opposite to the top surface 111.

Referring to FIG. 6, the first tongue 12 is essentially U-shaped from a front view and includes a rectangular flat portion 121 and a pair of raised portions 122 extending upwardly and outwardly from top corners of the flat portion 121. Each raised portion 122 defines a curved outer guiding surface 123. As clearly shown in FIG. 6, an outermost section (not labeled) of the curved outer guiding surface 123 extends horizontally beyond a corresponding lateral edge 124 of the flat portion 121. Besides, the first tongue 12 is smaller than the first body 11 not only in width but also in height so that the first tongue 12 can be of a suitable profile for being inserted into the receptacle connector 200. The flat portion 121 includes a top mating surface 125 and a plurality of rectangular first passageways 14 extending through the top mating surface 125 for receiving the first contacts 20. The first passageways 14 further extend backwardly through the first body 11 so that the first contacts 20 can be inserted into the first passageways 14 along a back-to-front direction. It is understandable to those of ordinary skill in the art that the first contacts 20 can be retained in the first insulative housing 10 through other ways, such as insert-molding etc.

The first extension portions 13 function as retaining members for mounting to the circuit board. Each first extension portion 13 defines a first slit 131 extending through a rear surface 110 thereof and a first lateral cutout 132 in communication with the first slit 131. The first slit 131 and the first lateral cutout 132 cooperatively receive the first metal grounding piece 30.

As shown in FIGS. 3 and 4, the first metal grounding pieces 30 are symmetrical with each other and are assembled to the first extension portions 13 along the back-to-front direction. Each first metal grounding piece 30 includes a first flat retaining portion 31 fixed in the first slit 131, a first downward bent portion 32 received in the first lateral cutout 132 and a first claw 33 extending sidewardly beyond the first extension portion 13. The first claw 33 includes a pair of horizontal extensions 331 and a vertical extension 332 between the pair of horizontal extensions 331 for mounting to the circuit board.

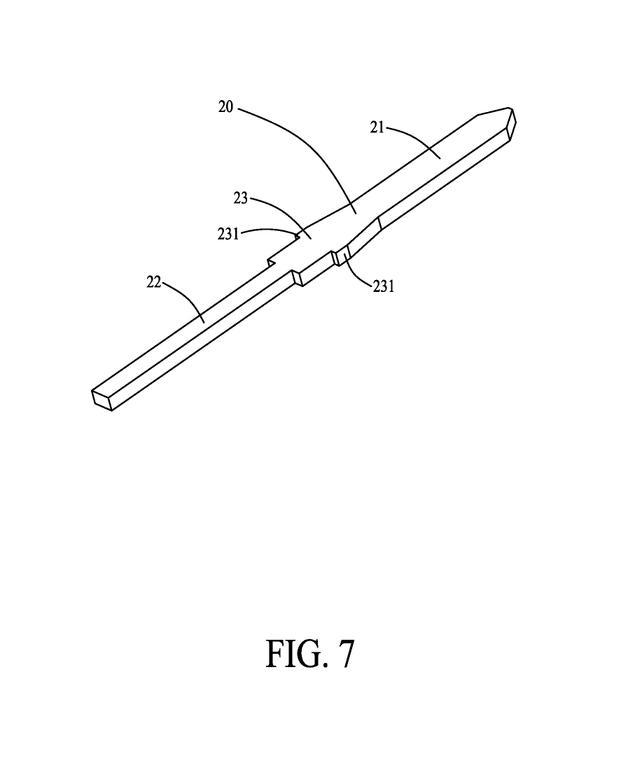

Referring to FIGS. 4 and 7, each first contact 20 includes a flat and rigid first contacting portion 21, a first soldering portion 22 extending into the first mounting space 110 and a first retaining portion 23 connecting the first contacting portion 21 and the first soldering portion 22. The first contacting portion 21, the first soldering portion 22 and the first retaining portion 23 are coplanar with each other so that the first contacts 20 can be easily inserted into the first passageways 14 from the back-to-front direction. The first contacting portions 21 are exposed on the top mating surface 125. The first retaining portion 23 includes a plurality of barbs 231 for engaging with an inner side of corresponding first passageway 14 for enhancing fixation force thereof so that the first contacts 20 can be stably maintained in the first passageways 14.

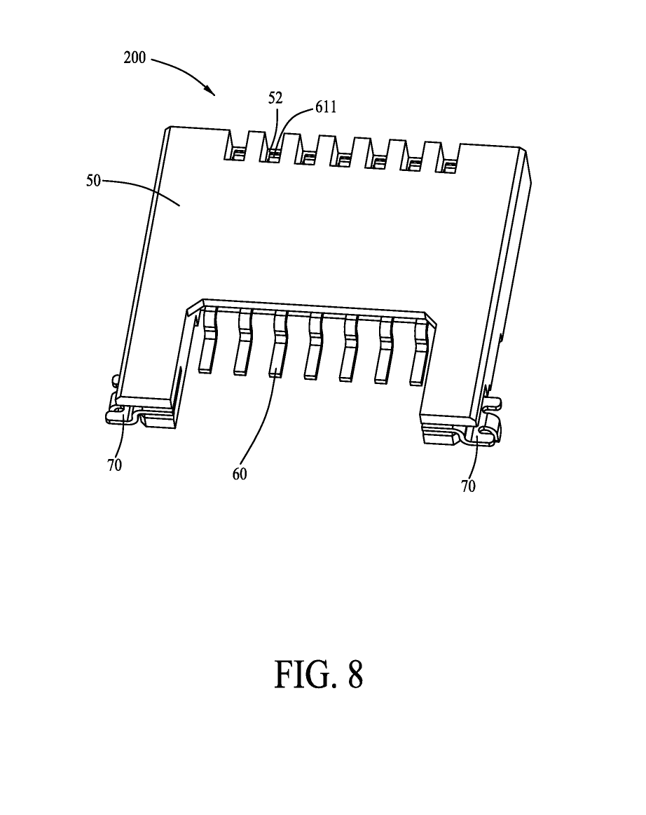

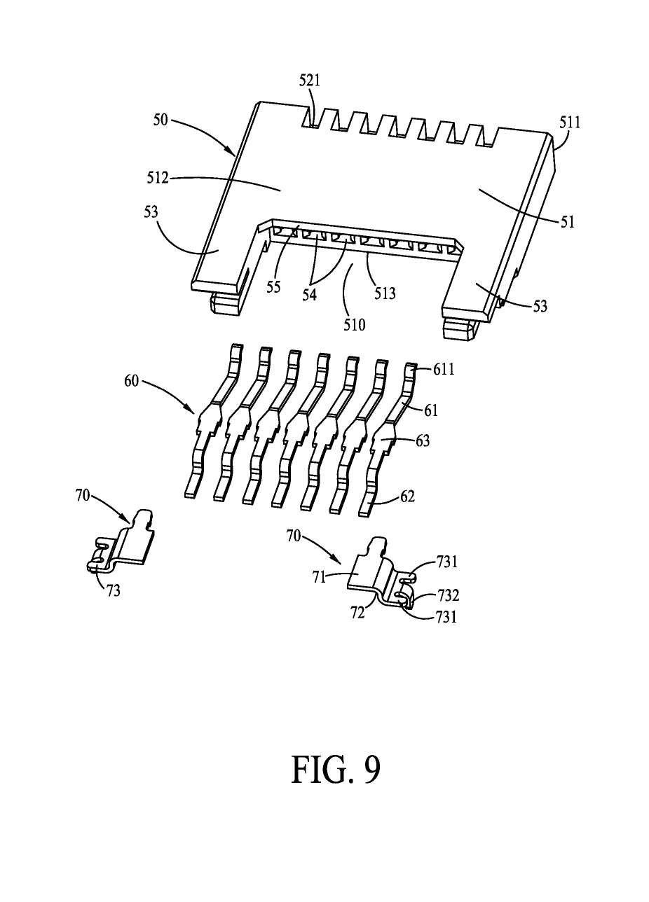

Referring to FIGS. 8 and 9, the receptacle connector 200 includes a second insulative housing 50, a plurality of second contacts 60 retained in the second insulative housing 50 and a pair of second metal grounding pieces 70 assembled to the second insulative housing 50.

Referring to FIGS. 9 to 11, the second insulative housing 50 includes a second body 51 and a pair of second extension portions 53 extending from opposite sides of the second body 51. The second body 51 and the pair of second extension portions 53 jointly form a U-shaped second mounting space 510. The second body 51 includes a front end surface 511, a top surface 512, a bottom surface 513, and an essentially U-shaped receiving cavity 514 recessed backwardly from the front end surface 511 and accordingly forming a second tongue 52 exposed to the receiving cavity 514. The U-shaped receiving cavity 514 includes a flat cavity 515 extending through the bottom surface 513 of the second body 51 and located below the second tongue 52 and a pair of enlarged holes 516 extending upwardly at opposite sides of the flat cavity 515. Each enlarged hole 516 includes a curved inner guiding surface 517 for mating with corresponding curved outer guiding surface 123 of the first tongue 12.

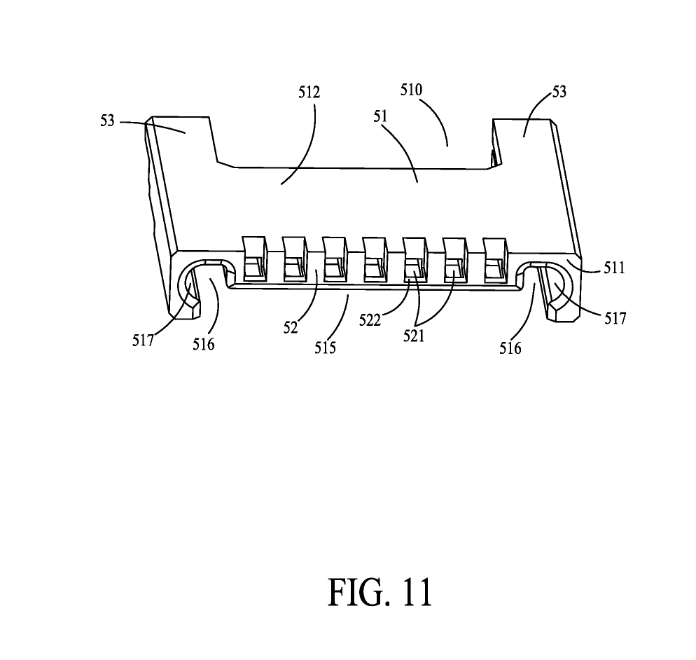

The second tongue 52 defines a bottom mating surface 520 and a plurality of second passageways 54 extending through the bottom mating surface 520. The second passageways 54 further extend backwardly through the second body 51 for mounting the second contacts 60 along the back-to-front direction as shown in FIG. 9. Besides, as shown in FIG. 11, the second tongue 52 further includes a plurality of rectangular heat-dissipation slots 521 extending through the top surface 512 and the front end surface 511 of the second body 51. The heat-dissipation slots 521 are in communication with corresponding second passageways 54 for receiving the second contacts 60. Because of forming the heat-dissipation slots 521, the second tongue 52 leaves a plurality of platforms 522 corresponding to the heat-dissipation slots 521. The heat-dissipation slots 521 not only function as dissipating heat when the first contacts 20 and the second contacts 60 are mated together but also as windows for observing mating status of the first contacts 20 and the second contacts 60.

Similar to the first extension portions 13, the second extension portions 53 function as retaining members for mounting to the circuit board. Each second extension portion 53 defines a second slit 531 extending through a rear surface 530 thereof and a second lateral cutout 532 in communication with the second slit 531. The second slit 531 and the second lateral cutout 532 cooperatively receive the second metal grounding piece 70.

As shown in FIG. 9, the second metal grounding pieces 70 are symmetrical with each other and are assembled to the second extension portions 53 along the back-to-front direction. The pair of second metal grounding pieces 70 are the same as the pair of first metal grounding pieces 30. Each second metal grounding piece 70 includes a second flat retaining portion 71 fixed in the second slit 531, a second downward bent portion 72 received in the second lateral cutout 532 and a second claw 73 extending sidewardly beyond the second extension portion 53. The second claw 73 includes a pair of horizontal extensions 731 and a vertical extension 732 between the pair of horizontal extensions 731 for mounting to the circuit board.

Each second contact 60 includes an elastic contacting arm 61 extending downwardly beyond the bottom mating surface 520, a second soldering portion 62 extending into the second mounting space 510 and a second retaining portion 63 connecting the contacting arm 61 and the second soldering portion 62. The elastic contacting arm 61 includes a cantilevered tip end 611 received in the heat-dissipation slot 521 and abutting against the platform 522 to prevent the second contacts 60 from over deformation. The elastic contacting arms 61 are deformable in the second passageways 54 during mating with the first contacting portions 21 of the first contacts 20. Besides, the second retaining portion 63 includes a plurality of barbs 631 for engaging with an inner side of corresponding second passageway 54 for enhancing fixation force thereof so that the second contacts 60 can be stably maintained in the second passageways 54.

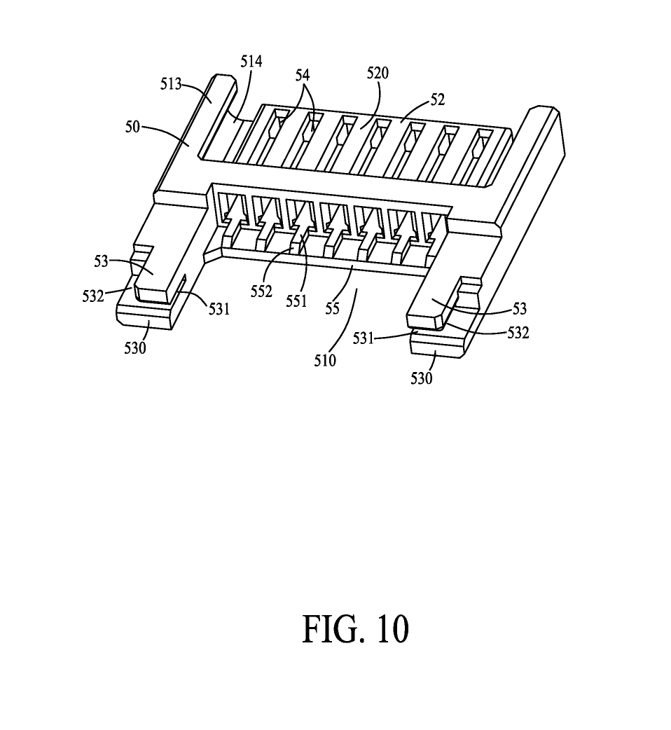

Referring to FIGS. 9 and 10, in order to better guiding insertion of the second contacts 60 into the second passageways 54, the second insulative housing 50 includes an eave 55 extending backwardly from the second body 51. The eave 55 includes a plurality of separate blocks 551 each of which defines an inclined guiding surface 552 for guiding insertion of the second contacts 60 into the second passageways 54.

When the plug connector 100 is inserted into the receptacle connector 200, under guidance of the curved inner guiding surfaces 517 and the curved outer guiding surfaces 123, the first tongue 12 is received in the U-shaped receiving cavity 514. The pair of raised portions 122 are received in the pair of enlarged holes 516. The top mating surface 125 of the first tongue 12 directly faces the bottom mating surface 520 of the second tongue 52. The first contacts 20 are inserted under the second contacts 60 with the elastic contacting arms 61 deformably engaging with the flat and rigid contacting portions 21. A configuration of the electrical connector assembly 1 is H-shaped when the plug connector 100 and the receptacle connector 200 are mated together. The top surfaces 111, 512 and the bottom surfaces 112, 513 of the first body 11 and the second body 51 are coplanar with each other, respectively. As a result, structures of the plug connector 100 and the receptacle connector 200 are well simplified for realizing cost-effective manufacture.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. An electrical connector comprising:
a first insulative housing comprising a first body, a first tongue extending forwardly from the first body and a pair of first extension portions extending backwardly from opposite sides of the first body, the first tongue being essentially U-shaped from a front view, the first tongue comprising a rectangular flat portion and a pair of raised portions extending upwardly and outwardly from top corners of the flat portion, the first body jointly with the pair of first extension portions forming a U-shaped first mounting space; and
a plurality of first contacts retained in the first insulative housing, each first contact comprising a flat and rigid first contacting portion exposed on a top mating surface of the flat portion and a first soldering portion extending into the first mounting space; wherein
each raised portion defines a curved outer guiding surface for being easily inserted into a cavity of a mateable connector.

2. The electrical connector as claimed in claim 1, wherein an outermost section of the curved outer guiding surface extends horizontally beyond a corresponding lateral edge of the flat portion.

3. The electrical connector as claimed in claim 1, wherein the first tongue is smaller than the first body not only in width but also in height.

4. The electrical connector as claimed in claim 1, wherein the flat portion defines a plurality of first passageways extending through the top mating surface so as to receive the first contacting portions, and the first contacting portion and the first soldering portion of each first contact are coplanar with each other.

5. The electrical connector as claimed in claim 1, wherein the pair of first extension portions are equipped with a pair of first metal grounding pieces, respectively, the pair of first metal grounding pieces being symmetrical with each other and assembled to the first insulative housing along a back-to-front direction.

6. The electrical connector as claimed in claim 5, wherein each first extension portion defines a first slit and a first lateral cutout in communication with the first slit, and each first metal grounding piece comprises a first flat retaining portion fixed in the first slit, a first downward bent portion received in the first lateral cutout and a first claw extending beyond the first extension portion.

7. The electrical connector as claimed in claim 6, wherein the first claw comprises a pair of horizontal extensions and a vertical extension between the pair of horizontal extensions for mounting to a circuit board.

8. An electrical connector comprising:
a second insulative housing comprising a second body which defines a front end surface, a top surface and a bottom surface, the second body defining an essentially U-shaped receiving cavity recessed backwardly from the front end surface and accordingly forming a second tongue exposed to the receiving cavity, the U-shaped receiving cavity comprising a flat cavity extending through the bottom surface of the second body and located below the second tongue and a pair of enlarged holes extending upwardly at opposite sides of the flat cavity, the second tongue defining a bottom mating surface; and
a plurality of second contacts retained in the second insulative housing, each second contact comprising an elastic contacting arm extending downwardly beyond the bottom mating surface and a tip end cantileveredly extending from the contacting arm; wherein
the second body defines a plurality of heat-dissipation slots extending through the top surface to receive the tip ends of the second contacts.

9. The electrical connector as claimed in claim 8, wherein the second tongue defines a plurality of second passageways extending through the bottom mating surface, the elastic contacting arms being deformable in the second passageways.

10. The electrical connector as claimed in claim 8, wherein each enlarged hole comprises a curved inner guiding surface.

11. The electrical connector as claimed in claim 8, wherein the heat-dissipation slots extend through the front end surface of the second insulative housing.

12. The electrical connector as claimed in claim 8, wherein the second body comprises a plurality of platforms corresponding to the heat-dissipation slots, the tip ends of the second contacts abut against the platforms to prevent the second contacts from over deformation.

13. The electrical connector as claimed in claim 8, wherein the second insulative housing comprises a pair of second extension portions extending backwardly from opposite sides of the second body, the second body jointly with the pair of second extension portions forming a U-shaped second mounting space, each second contact comprising a second soldering portion extending into the second mounting space.

14. The electrical connector as claimed in claim 13, wherein each second extension portion is equipped with a second metal grounding piece which is assembled to the second insulative housing along a back-to-front direction.

15. The electrical connector as claimed in claim 14, wherein each second extension portion defines a second slit and a second lateral cutout in communication with the second slit, and each second metal grounding piece comprises a second flat retaining portion fixed in the second slit, a second downward bent portion received in the second lateral cutout and a second claw extending beyond the second extension portion, the second claw comprising a pair of horizontal extensions and a vertical extension between the pair of horizontal extensions for mounting to a circuit board.

16. An electrical connector assembly for connecting two circuit boards, comprising:
a plug connector comprising:
a first insulative housing defining a first body, a first tongue extending from the first body and a pair of first extension portions extending from opposite sides of the first body, the first tongue being essentially U-shaped from a front view and defining a top mating surface, the first body jointly with the pair of first extension portions forming a first mounting space opposite to the first tongue; and
a plurality of first contacts retained in the first insulative housing, each first contact comprising a flat and rigid contacting portion exposed on the top mating surface and a first soldering portion extending into the first mounting space; and
a receptacle connector for mating with the plug connector, the receptacle connector comprising:
a second insulative housing defining a second body and a pair of second extension portions extending from opposite sides of the second body, the second body defining an end surface and a U-shaped receiving cavity recessed from the end surface so as to form a second tongue, the second tongue defining a bottom mating surface, the U-shaped receiving cavity being configured to receive the first tongue, the second body jointly with the pair of second extension portions forming a second mounting space; and
a plurality of second contacts retained in the second insulative housing, each second contact comprising an elastic contacting arm extending beyond the bottom mating surface and a second soldering portion extending into the second mounting space; wherein
when the plug connector and the receptacle connector are mated together, the first tongue is received in the U-shaped receiving cavity with the top mating surface directly facing the bottom mating surface and the elastic contacting arms of the second contacts deformably engaging with the flat and rigid contacting portions of the first contacts.

17. The electrical connector assembly as claimed in claim 16, wherein the first tongue comprises a pair of curved outer guiding surfaces and the U-shaped receiving cavity comprises a pair of curved inner guiding surfaces for mating with the curved outer guiding surfaces when the plug connector and the receptacle connector are mated together.

18. The electrical connector assembly as claimed in claim 16, wherein a configuration of the electrical connector assembly is H-shaped when the plug connector and the receptacle connector are mated together, top surfaces and bottom surfaces of the first body and the second body being coplanar with each other, respectively.

19. The electrical connector assembly as claimed in claim 16, wherein each contacting arm comprises a cantilevered tip end extending therefrom, the second body defining a plurality of heat-dissipation slots extending through the end surface to position the tip ends, the heat-dissipation slots not only functioning as dissipating heat when the first contacts and the second contacts are mated but also as windows for observing mating status of the first contacts and the second contacts.

20. The electrical connector assembly as claimed in claim 16, wherein the pair of first extension portions are equipped with a pair of first metal grounding pieces which are symmetrical with each other, the pair of second extension portions are equipped with a pair of second metal grounding pieces the same as the pair of first metal grounding pieces.
